(19) United States
(12) Patent Application Publication
(10) Pub. No.: US 2014/0281877 A1
(43) Pub. Date: Sep. 18, 2014

(54) Website Excerpt Validation and Management System

(71) Applicant: Pandexio, Inc., Hermosa Beach, CA (US)

(72) Inventors: John Richard Burge, Manhattan Beach, CA (US); Simon Politakis, Hermosa Beach, CA (US)

(73) Assignee: Pandexio, Inc., Hermosa Beach, CA (US)

(21) Appl. No.: 14/216,598

(22) Filed: Mar. 17, 2014

Related U.S. Application Data
(60) Provisional application No. 61/788,106, filed on Mar. 15, 2013.

(51) Int. Cl. G06F 17/24

(52) U.S. Cl. CPC G06F 17/241
USPC 715/230

(57) ABSTRACT

The inventive subject matter provides apparatus, systems and methods in which a user could mark one or more sections of one or more documents to create an annotation in a manner to easily enable verification of the annotation. An annotation comprises user-defined data associated with the one or more sections, such as, for example, a summary, a common conclusion, a common quote, a common comment, or a common attribute. For example, a user could select a plurality of sections in one or more documents that all support a common conclusion, and could create an annotation comprising the common conclusion linked to each of the sections. Upon request by a user to verify the annotation, the system can present the relevant sections of the document from which the annotation is derived.

This application claims the benefit of U.S. provisional application No. 61/788,106 filed Mar. 15, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is annotation validation and management systems.

### BACKGROUND

The following description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Knowledge workers, such as students, researchers, and data aggregators, receive a tremendous amount of content which they must read, process and understand. As a result, tools that help such users capture and save the most relevant pieces of content they view are becoming more and more popular, such as the Google Chrome® web clipping extension to Evernote®. While these tools may present handy ways to capture web pages and in some cases sub-parts of web pages, their design, function and data structure pose several drawbacks for performing knowledge work.

U.S. Pat. No. 5,659,729 to Nielsen teaches a system and method for leveraging HTML extensions to support remotely specified named anchors that act as hypertext links to associated documents.

This allows a remote user to associate relevant documents with one another to create logically linked nodes of content. Nielsen's system, however, fails to allow a user to add notes to such links, explaining what the logical connection is between the two documents that have been linked by the named anchor.

US2002089533 to Hollaar teaches a system that allows a user to create a reference document that contains highlighted passages of a perused document. When a user clicks on a passage in the referenced document, Hollaar's system will retrieve the source document containing the quoted passage, and display the source document with the aforementioned passage highlighted. While Hollaar's system allows a user to create a reference document with a bit more context by creating highlighted passages, some source documents are written in such a cryptic manner, or sometimes in another language entirely, that using highlighted passages to create context isn't always useful.

US2012317468 to Duquene teaches a system that allows a user to review a referencing document, and create a referenced document containing comments about various sections of the referencing document. The comments are linked to specific sections of the referencing document, and both documents can be viewed side-by-side so that a user could see at a glance how comments in the referenced document refer to specific sections of the referencing document. However, Duquene fails to allow the referencing document to change over time as more and more information is added. Duquene also only allows a single comment to be attributable to a single place in a referencing document, where a knowledge worker might derive a useful insight by pulling together data from multiple portions in a same document, or even multiple portions of different documents.

This can be quite problematic and frustrating, particularly for knowledge workers who seek to curate their excerpts and related sources as part of their knowledge base. Or, for those who seek to provide a deliverable to others based on referenceable, verifiable excerpts of content as is typical in research, academic and other settings where citation systems are commonly used for this purpose. Web pages are dynamic entities. Their content frequently changes, their location frequently changes, and users tend to reference a plurality of documents to come to a single conclusion.

Thus, there remains a need for a system and method that enables efficient and effective capturing of content excerpts in a manner that enables rapid verification of source and context without manual navigation in the Internet, re-reading of web pages every time one wants to verify source and context, or relying on website owners maintaining their pages at the exact same web address in the exact same form in perpetuity.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems and methods in which a user could mark one or more sections of one or more documents to create an annotation in a manner to easily enable verification of the annotation. As used herein, a document is a logical grouping of text, images, sounds, and/or videos in any suitable format, for example a file format or a web page format. As used herein, an annotation comprises user-defined data associated with the one or more sections, such as, for example, a summary, a common conclusion, a common quote, a common comment, or a common attribute. For example, a user could select a plurality of sections in one or more documents that all contain a common quote, and could create an annotation comprising the common quote which is linked to each of those sections, or a user could select a plurality of sections in one or more documents that all support a common conclusion, and could create an annotation comprising the common conclusion linked to each of the sections.

The system is preferably implemented on one or more computer systems. It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The computer system is generally configured to have a verification database module and a verification engine module, where the verification database module is configured to store annotation objects and document objects on one or more compute readable storage mediums. Each document object typically corresponds to a source document, and each annotation object typically has some annotation content, and is associated with one or more sections of one or more source documents.

The verification engine module is typically configured to communicate with the verification database, communicates with a user through one or more user interfaces, and enables such a user to create, instantiate, associate, and verify annotation objects and document objects where appropriate. A user typically interacts with the verification engine through such a user interface and triggers an annotation event through an interaction with one or more source documents, defining at least a portion of the annotation event. For example, a user could select one or more source documents, causing the verification engine to then instantiate an annotation object comprising a section of a source document, multiple sections of the source document, or even multiple sections of multiple source documents, depending upon need. Once the source document(s) is(are) instantiated, the user could select one or more sections of the instantiated document(s), such as by identifying a boundary around the section of the source document.

The user could also define annotation data, for example by providing a statement, a quote, a clip, or a video that the user then associates with the selection(s) through the user interface. The system preferably ensures that the user has reviewed the sections before creating the annotation, for example by triggering a flag every time the user reviews a section, and then only allows a user to select a section once the system detects that the flag is triggered.

The annotation object will typically contain the user-created annotation data, and one or more reference identifiers that identify the portion(s) of the document(s) that are linked to the annotation object. Contemplated reference identifiers include uniform resource locators (URLs) identifying a section of webpage, coordinates that identify a section of an image, a set of timestamps identifying a section of a video or an audio document, or some other associated identifier that can identify the section. Preferably, the verification system limits the user to selecting a section that is easily viewable within a screen, such as a 480×640 window, so the section is easily verifiable, although contemplated embodiments allow a user to select sections that span multiple screens.

The verification engine is also preferably configured to allow a user to verify any of the created annotation objects, typically through the user interface, which is configured to at least display one of the sections of documents associated with the annotation object. For example, a user could select an annotation object, which displays one of the sections, and then the user could indicate whether the annotation is correct or not. If the user determines that the annotation is correct or mostly correct, the user could contribute a positive vote that increases a confidence score of the annotation, which could be a binary vote (yea or nay) or a score (for example based off of a scale from 1-5, 1-10, or 1-100). Otherwise, if the user determines that the annotation is incorrect or mostly incorrect, the user could contribute a negative vote that decrease a confidence score of the annotation in a similar manner. In alternative embodiments, the user could even alter the annotation to improve the accuracy of the annotation. More information about this annotation rating system can be found in a co-owned U.S. patent application Ser. No. 14/162,593 entitled “Assertion Quality Assessment and Management System,” filed Jan. 23, 2014.

Preferably, the verification engine is configured to display more than one selected section on the screen in order to allow a user to analyze a plurality of data simultaneously when verifying the annotation. For example, where the annotation is a common quote between a plurality of text documents, it's useful to compare many of the quotes against one another by displaying at least 2 or more of the document sections on the user interface along with the annotation. Or where the annotation is a comment tying a common thread between a series of text documents, a series of image documents, and a series of video documents, it's useful to display 2 or more of the documents on the screen to compare them with the common thread. In a preferred embodiment, where certain documents become more relevant or become irrelevant to the annotation, the user could then remove one or more sections from the annotation object, or add one or more sections to an existing annotation object.

In other embodiments, where there exist a plurality of annotations for a common section of a document (or sections of a document, or sections of a plurality of documents), a user could view many annotations side-by-side and compare them to the source material to figure out which annotation is superior to another annotation. This is particularly useful, for example, when a plurality of users create comments about a specific section of a document, and the user wants to promote or demote certain comments over others. While a plurality of annotations may be linked to the exact same section of a document (for example, all annotations correspond to the 16^{th} paragraph of a treatise or to time stamps 2:03-4:16 in a video), it is far more likely that the selected sections for each annotation object merely overlap one another. Thus, where a user wishes to compare a plurality of annotation objects, the verification engine preferably groups the annotation objects by sections of documents that overlap one another. The verification engine might be fine-tuned to only allow annotation objects with sections that overlap a great deal, such as by more than 80% or 90%, or could be broadened to allow any overlap, such as by at least 10% or at least 1% Annotation objects might also be compared to one another if they are tagged with information that is common to one another. For example, a user might wish to compare all annotation objects tagged with the label “first amendment” or “cute cats.”

Some source documents change over time, which is especially true when the source document is an updatable webpage or URL. To compensate for such changes, the verification engine is preferably configured to detect when a source document has changed, and update the annotation objects linked to the changed source document accordingly. In a simple form, the verification engine might be configured to flag an annotation object if it is linked to a source document that has changed, enabling astute users to sift through all of the flagged annotation objects and verify if the annotation object is still correct. In more advanced forms, the verification engine might be configured to scan through the updated source document, determine if the selected section has data that overlaps with the updated source document, and associate the annotation object with the new section of the source document in lieu of the old, outdated section of the source document. Of course, when the system makes such a change automatically, a flag might be introduced that informs a user that a re-association has been made, and the user may wish to verify the re-association to ensure that the system correctly re-associated the annotation with the new content. Static version of old source documents may be captured and stored by the system to assist in the comparison, along with their special relationship and associated metadata, enabling subsequent users to verify source and context of clips at a future time as compared to the captured source documents. In some embodiments, a plurality of old source documents are captured to allow a user to trace through changes of the source document through time. This is particularly useful for annotations that may point to a section of a first version of a source document, and a section of a second version of a source document.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example verification engine of some embodiments.

FIG. 2 illustrates a user interface of some embodiments for initiating an annotation event.

FIG. 3 illustrates content of an example document object.

FIG. 4 illustrates content of an example annotation object.

FIG. 5 illustrates a user interface of some embodiments for presenting excerpts and source documents based on an annotation object.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

One should appreciate that the disclosed techniques provide many advantageous technical effects including the ability to create an annotation that references a plurality of sections of one or more source documents, verify such annotations, and compare such annotations against other ones to promote the most accurate annotations.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventive subject matter provides apparatus, systems and methods for validating an excerpt from a source document (and optionally an annotation of the excerpt). As defined herein, an excerpt means a portion (a section) of any document (e.g., one or more pages, one or more paragraphs, one or more words, one or more sentences, etc.), and an annotation is what a knowledge worker derives from the excerpt (e.g., an opinion, a question, a fact, a conclusion, a point, etc.). The apparatus, systems, and methods allow for efficient validation of the excerpt and the annotation by presenting the source document to the reader of the annotation upon request. In some embodiments, the source document is presented in a way that the excerpt is emphasized within the source document. When knowledge workers build on top of their own materials or third party materials, the authors of such materials usually provide citations or annotations to the work upon which the authors rely. The present system allows knowledge workers to organize and verify such annotations to better support a research paper or conclusion.

In one aspect of the invention, a source verification system for verifying excerpts is presented. The source verification system includes a verification database that is configured to store annotation objects and document objects. Each document object corresponds to a source document. The source verification system also includes a verification engine that is coupled to the annotation object database. The verification engine is configured to instantiate an annotation object upon receiving an annotation event. The instantiated annotation object includes a section (portion) of a source document. The verification engine is also configured to associate the annotation object with a document object that corresponds to the source document based on the annotation event. The verification engine then configures an output device to present the source document upon a request to verify the annotation content.

FIG. 1 illustrates the schematic of a verification system 100. The verification system 100 includes a verification engine 102 that is coupled with a verification database 120. In some embodiments, the verification database 120 can be local to the verification engine 102 as illustrated in FIG. 1, while in other embodiments, the verification database 120 can be remote to the verification engine 102. In some embodiments, the verification database 120 is an electrical storage that can comprise a file system, database management system, a document, a table, etc. The verification database 120 of some embodiments is implemented in non-transitory data storage such as a hard drive, a flash memory, etc. The verification database 120 is configured to store document objects (such as document objects 140 and 145) and annotation objects (such as annotation objects 150 and 155).

The verification engine 102 also includes a verification management module 105, an annotation verification module 115, an annotation objects generation module 110, and a user interface 125. In some embodiments, the verification management module 105, the annotation verification module 115, the annotation objects generation module 110, and the user interface 125 can be implemented as software modules that are executable by one or more processors.

The verification management module 105 is configured to manage the interactions among the different modules within the verification engine 102, the database 120, and users. The annotation objects generation module 110 is configured to generate new excerpts (and also annotations) for users while annotation verification module 115 is configured to allow users to verify existing excerpts/annotations.

As shown, the verification engine 102 is configured to interact with different users (such as users 130 and 135) via the user interface 125. The user interface 125 can provide a graphical user interface (GUI) via a client device (e.g., PC, laptop, tablet, smart phone, etc.) to prompt users for data and present information to the users. In some embodiments, at least some of the modules (or portions of some of the modules) within the verification engine 102 can be implemented at the client device.

Users can use services provided by the verification engine 102 via the user interface 125. For example, a user (e.g., user 130) can create a new excerpt (and annotation) using the verification engine 102. To do so, user 130 would initiate an annotation event. In some embodiments, the annotation event comprises a selection of a portion of a source document (i.e., excerpt). In some other embodiments, the annotation event also comprises adding annotation content (e.g., points, facts, conclusions, analysis or other annotations derived from the portion of the source document).

FIG. 2 illustrates an example interface 200 that allows user 130 to create a new excerpt/annotation. Specifically, the interface 200 includes a web browser 205 that includes an annotation generation tool. The web browser 205 could be any kind of browser (e.g., Internet Explorer®, Google Chrome®, Mozilla Firefox®, Apple Safari®, etc.) that allows the user to view web pages at a client device. The annotation generation tool could be implemented as a booklet, an applet, javascript, etc., that can be run on the web browser, and typically incorporates some sort of clipping engine that enables the user to run such custom code within the web browser. Contemplated clipping engines include a browser extension or browser plug-in, and could include a user interface, including an activation mechanism that activates the running of the clipping engine.

As shown, user 130 has directed web browser 205 to go to a URL 210 the presents a transcript of the Constitution of the United States, source document 220. When the web browser 205 includes the annotation generation tool, an interface (e.g., an annotate button 215) can appear for the user to initiate an annotation event while browsing a webpage. In some embodiments, the annotation event includes selection of a portion of a source document. Thus, once user 130 initiated an annotation event (e.g., by selecting the annotate button 215), user 130 can select a portion of the document (e.g., excerpt 225) being viewed on the browser 205 (e.g., by a click-and-drag operation with a cursor). In this example, the excerpt 225 is defined by a dotted line border within the source document 220. The document showing on the web browser 205 becomes a source document 220 for the excerpt 225.

Where the document is a remote text document, chart, widget, image, or video, a proxy (not shown) may be needed to avoid cross-domain security issues. Contemplated proxies may sit within the computer system environment, and may be a REST API endpoint exposed as a URL or other form of proxy. When the annotation event is triggered, the system could detect that a remote document is not from the host domain of the web page, and make a request to the proxy, passing the original URL of the remote document so that the proxy can download the remote document and convert it to a data URL which it returns in response to the proxy call. The remote document is then rendered on user interface 200 as source document 220 using the data URL as the source network address instead of the original network address of the remote document.

In addition to selection of the excerpt 225, annotation generating interface 200 can also allow user 130 to add annotation content that is associated with the excerpt 225. In some embodiments, the interface 200 can generate a separate window 245 that includes the excerpt 225 and also a text input box 260 that allows user 130 to insert annotation content. In some embodiments, the addition of annotation content is also part of the annotation event.

In some embodiments, the interface 200 also includes text input boxes 230 and 235 that allows user 130 to provide title and tags for the source document 220 and save button 240 that enables the user to save changes. Input box 235 is used to include keywords and/or tags that the user desires to associate with an annotation, folders the user would like to route them into, or other attributes or metadata that could facilitate organization. In some of these embodiments, data related to the selection of the excerpt 225, the annotation content text box 260, URL of the source document 220, title of the source document 230, and tags for the document 235 is sent to the verification engine 102 as part of the annotation event. Any of this metadata could be pulled automatically by the system; for example the system could automatically extract a web page title from the HTML of a web page document. Upon detecting the annotation event, verification engine 102 first determine whether a document object for the source document 230 already exists within verification database 120 based on the URL 210 and/or content of the source document. If it is determined that a document object for source document 230 exists within database 120, the verification management module 105 retrieves the document object and updates it with the new title and tags information. Alternatively, if it is determined that no document object for source document 230 exits in database 120, verification management module 105 uses annotation objects generation module 110 to instantiates a new document object for source document 230, and inserts new data such as URL 210, title 230, and tags 235 into the newly instantiated document object.

The interface 200 may also include links or buttons (not shown) that enable the user to save the web page and clips and apply labels.

FIG. 3 illustrates example data that can be included within a document object 300 generated by the verification engine 102 for a particular source document. As shown, document object 300 has many attributes related to a source document, including (but not limited to) document identifier 305, document address 310, document title 315, document description 320, tags 325, document content 330, creator identifier 335, creation date 340, DRM data 345, association count 350, and view count 355. Data for these attributes can be added at the time of instantiation or added at a later time. Some of these attributes can also be updated after the document object 300 has been instantiated. As used herein, DRM data could represent information extracted from within HTML code on a web site that is related to copyright or other intellectual property rights asserted from the web site. That DRM data could include a copyright metatag, a Creative Commons attribution link, or other means by which web sites commonly include statements that define copyright rights. This DRM tag may be used by the system to authorize certain users to view copyrighted source material that the user has a license to view. The system could house a user database that houses username/password information for a user's license, allowing that user to access restricted documents, such as for example published PhD papers that can only be accessed with a license or newspaper articles that can only be accessed through a subscription ID.

Document identifier 305 can be any form of identifier known in the art that can uniquely identify a document object within the verification database 120 (e.g., a primary key, a uniform resource identifier (URI) of the source document, etc.). It can also be used to link one or more annotation objects (with excerpts and annotations based on the source document of document object 300) to the document object 300, by including the document ID as one of the attributes in an annotation object. The linking between document objects and annotation objects will be explained in more detail below.

Document address 310 can include data that can identify a location to retrieve the original copy of the source document (e.g., a publication identifier, a uniform resource locator (URL), etc.). The document address 310 can be used when a user requests to view the original source document.

Document title 315 can include a title of the source document. The annotation objects generation module 110 of some embodiments can retrieve information from metadata of the source document (e.g., HTML tags from the source code of a webpage, or metadata of a PDF file, etc.). In some embodiments, the annotation objects generation module 110 can prompt the creator of the document object for title information via the interface 200 (e.g., see title text box 230 of interface 200).

Document description 320 includes brief description of the source document. Similar to document title 315, the annotation objects generation module 110 can either retrieve the information from metadata of the source document or prompts a user for this information.

Tags 325 can include keywords related to the source documents. Again, the annotation objects generation module 110 can either retrieve the tags information from metadata of the source document or prompts a user for this information (e.g., see tags text box 235 of interface 200). Tags can be used for effective searching, querying of document objects.

Document content 330 includes an image of the source document. The image can be in any one of the widely used formats known in the arts (e.g., PDF, TIFF, JPEG, etc.) that allow for easily retrieving, reading of, and searching within the source document. In addition to the image, document content 330 in some embodiments can also include the plain content of the source document (e.g., text, image, audio, video, etc.).

Creator identifier 335 includes data that can uniquely identify a user who created the document object 300. Creation date 340 includes timestamp data that indicates the time that document object 300 was instantiated. When a source document is updated, the system could either replace the document in the database and update its creation date, or could create a new source document in the database having a new creation date, and treat both source documents as separate, but related, entities. DRM data 345 includes digital right management data for setting rights policy for the source document.

Association count 350 includes data indicating how many annotation objects are associated with the document object 300. View Count 355 includes data indicating how many times the document object 300 has been accessed by users.

Referring back to FIG. 1, after a document object is instantiated or retrieved for source document 220, annotation objects generation module 110 also instantiates an annotation object based on the annotation event. FIG. 4 illustrates an example annotation object 400 generated by annotation objects generation module 110 of some embodiments. As shown, annotation object 400 has many attributes, including (but not limited to) annotation identifier 405, associated document identifier 410, annotation title 415, annotation content 420, keywords 425, extracted text of clip 430, clip image 435, clip location data 440, clip size 445, creation date 450, and view count 455.

Annotation identifier 405 can be any form of identifier known in the art that can uniquely identify an annotation object within the verification database 120 (e.g., a primary key, a uniform resource identifier (URI) of the source document, etc.). Associated document identifier 410 includes data that directs verification engine 102 to a particular document object with which the annotation object 400 is associated. In some embodiments, associated document identifier 410 can be a pointer within the database 120 that points to the corresponding associated document object. In other embodiments, associated document identifier 410 corresponds to document identifier attribute 305 of document object 300. Thus, it includes the document identifier 305 of the associated document object. In some embodiments, annotation objects generation module 110 determines the associated document object based on the annotation event.

As mentioned above, upon detecting the annotation event, verification engine 102 either instantiate or retrieve a document object associated with the source document from which the excerpt is extracted and optionally, the annotation is derived. Thus, annotation objects generation module 110 can use document identifier of the document object that was instantiated or retrieved for the source document for the associated document identifier attribute 410 of annotation object 400.

This attribute provides the link between the annotation object 400 and its associated document object that would allow verification engine 102 to easily retrieve information (e.g., content, location, etc.) about the source document that is related to the excerpt/annotation.

Annotation title 415 includes a title for the annotation content Annotation objects generation module 110 can automatically derive this data from the content of the annotation or prompt the creator of the annotation object for this information.

Annotation content 420 includes content of the annotation. This data corresponds to what the user provides in the annotation content text box 260 of the interface 200. The annotation content is usually what the user derives from the excerpt of the source document, such as an opinion, a fact, an analysis, a conclusion, etc. Keywords 425 are tags or keywords that a user can associate with an annotation (or annotation content) so that it can be searched and/or queried subsequently Annotation objects generation module 110 can automatically derive this data from the content of the annotation or prompt the creator of the annotation object for this information.

Extracted text of clip 430 includes plain data (e.g., text, image, audio, video) of the excerpt that the user has selected (clipped) from the source document. Clip Image 435 is an image of the excerpt straight from the source document. It can be cropped from the document image of the document object 300. The image can be in any one of the widely used formats known in the arts (e.g., PDF, TIFF, JPEG, etc.) that allow for easily retrieving, reading of, and searching within the excerpt.

Clip location data 440 includes data that indicates a location of the excerpt within the source document. It can be represented as paragraph number(s), page number(s), word number(s), X-Y coordinates of diagonal points of a rectangular clip area, or any combination thereof. This information can be used to present the excerpt within the source document to a user (with the emphasis on the excerpt).

Clip size 445 could indicate the number of characters/words that are included in the excerpt, or could indicate the dimensions and coordinates of an image clip, or could indicate the start and end time stamps in a video clip. Creation date 450 includes timestamp data of the time that the annotation object is created. View count 455 includes the number of times that the annotation object has been accessed.

Confidence score 460 comprises a total confidence score taken from all users of the system who can vote to show how reliable annotation object 400 is. Confidence score 460 is preferably compiled from one or more votes from users. Where the vote is binary, a positive vote increases confidence score 460 by one unit, while a negative vote decreases confidence score 460 by one unit. Where the vote is on a scale, such as on a scale from 1-100, the confidence score is preferably calculated by determining the mean score among all voting users. In some embodiments, all users of the system could be considered voting users, while in other embodiments, only some users deemed “trustworthy” have permission to vote on how reliable annotation object 400 is.

Tag 465 comprises one or more tags that are associated with annotation object 400. Tags 465 are similar to keywords 425, but could be enacted from a pre-selected list of possible tags to increase the probability that annotation objects are grouped together appropriately. Updated flag 470 is a flag that is triggered when a document associated with annotation object 400 has been updated. Typically the system saves a copy of the document in its database, and queries the source document periodically (for example once a day or once every few hours) to determine if the document has been updated. If the flag has been triggered, the system could then alert one or more users of the system and inform those users that the document has been updated and that the annotation object may be outdated or need to be re-verified.

In some embodiments, the user can derive an annotation from more than one section with the same or different source documents. For example, the user can come up with a conclusion that can only be supported in view of multiple sections from different documents. In these embodiments, the verification engine 102 allows the user to associate an annotation object with more than one document (and/or more than one section within the same document). The interface 200 would allow the user to identify multiple sections (multiple boundaries) within the same or different documents before allowing the user to insert the annotation content. In addition, the annotation object 400 would include multiple associated document IDs and clip location data for multiple clips for the associated documents.

Referring back to FIG. 1, after the annotation object and/or document object has been instantiated, verification management module 105 stores the annotation object and/or the document object in the verification database 120 for future access by users. User 130 can incorporate the newly instantiated annotation object into her work (e.g., her publication, her webpage, etc.). Another user (e.g., user 135) who is reading the work of user 130 can recognize (through an interface that indicates annotations in the document, an example would be a different color font used for the annotation and/or underlining of the annotation) that the work includes an annotation that user 130 has derived from another piece of work (i.e., the source document). The document that user 130 created has embedded data (metadata) that identifies the annotation object associated with the annotation. User 135 can indicate to the interface to view and/or verify the annotation object (e.g., by clicking on to the annotation within user 130's document).

When verification engine 102 receives the indication that a user (e.g., user 135) wants to view a particular annotation object, verification engine provides an interface that allows user 135 to browse through annotation objects and verify content within the annotation objects (e.g., the excerpts and annotations). FIG. 5 illustrates an example interface 500 for providing annotations/excerpts verification for users.

As shown in FIG. 5, interface 500 includes a display area 505 for displaying a title of the source document being viewed at the time, display area 510 for displaying the source document, and display area 515 for displaying a list of annotation objects. Upon detecting that user 135 would like to view and/or verify the annotation object created by user 130, annotation verification module 115 first retrieves the annotation object from the verification database 120 based on the embedded data of user 130's document Annotation verification module 115 can use the display area 515 to display information related to the annotation object (e.g., annotation title, annotation content, keywords, etc.).

Annotation verification module 115 can also retrieve the document object associated with the annotation object from verification database 120 based on the associated document identifier attribute of the annotation object. Once the associated document object is retrieved, annotation verification module 115 can display information related to the document object in display areas 505 and 510. For example, annotation verification module 115 can display the document title of the document object in display area 505. Annotation verification module 115 can also display the source document (e.g., source document 220) (in image format or plain data (e.g., plain text) format) in display area 510.

In order to make it easier for user 135 to verify the annotation/excerpt, instead of displaying the source document 220 from the beginning, annotation verification module 115 configures the interface 500 to display the source document 220 in such a way that the portion of the document (the excerpt) associated with the annotation object is immediately viewable in display area 510 (e.g., displayed at the top of the display area 510) without user's interaction. In some embodiments, this feature requires the interface 500 to scroll the source document 220 to a spot where the excerpt is shown, based on the clip location data 440 of the annotation object.

In some embodiments, annotation verification module 115 also configures the interface 500 to highlight the excerpt 225 within the source document 220 being displayed in the display area 510, as shown in the figure. In addition, annotation verification module 115 can further configure the interface 500 to have an image of the excerpt 550 (based on clip image data 435) superimposed onto the source document 220, as shown in the figure.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A source verification system, comprising:
a verification database configured to store annotation objects and document objects, wherein each document object corresponds to a source document; and
a verification engine coupled to the annotation object database and configured to:
detect an annotation event comprising a user deriving an annotation based on a first section of a first source document and a second section of a second source document;
instantiate, in response to detecting the annotation event, an annotation object comprising the annotation,
associate the annotation object with a first document object comprising the first source document and a second document object comprising the second source document based on the annotation event, and
configure a user interface to present the first section of the first source document and the second section of the second source document to a user upon a request to verify the annotation object.

2. The source verification system of claim 1, wherein the annotation event further comprises a selection of the first section of the first source document and a selection of the second section of the second source document.

3. The source verification system of claim 1, wherein the annotation object further comprises a first reference identifier that identifies the first section.

4. The source verification system of claim 3, wherein the first reference identifier comprises a first uniform resource locator (URL) identifying a section of a webpage.

5. The source verification system of claim 3, wherein the first reference identifier comprises a first set of coordinates identifying a section of an image.

6. The source verification system of claim 3, wherein the first reference identifier comprises a first set of timestamps identifying a section of a video or audio document.

7. The source verification system of claim 1, wherein the first source document is identical to the second source document.

8. The source verification system of claim 1, wherein the verification engine is further configured to:
detect when the first source document has been updated, and
synchronize the annotation object with a fourth section of the first source document, wherein the fourth section of the first source document has content that overlaps with content from the first section.

9. The source verification system of claim 8, further comprising flagging the annotation object with an indicator when the first source document has been updated.

10. The source verification system of claim 1, wherein the user interface is further configured to simultaneously present a view of the annotation object with the first section.

11. The source verification system of claim 10, wherein the user interface is further configured to simultaneously present at least one of the second section and the third section with the first section.

13. The source verification system of claim 1, wherein the user interface is further configured to simultaneously present at least one more annotation object comprising a fourth section of the first source document with the first section, wherein at least a portion of the fourth section overlaps with at least a portion of the first section.

14. The source verification system of claim 1, wherein the user interface is further configured to simultaneously present at least one more annotation object comprising a fourth section of the first source document with the first section, wherein the fourth section has a tag that is the same as a tag of the first section.

15. The source verification system of claim 1, wherein the verification engine is further configured to receive a confidence vote from a user that affects a confidence score of the

[symbol]

16. The source verification system of claim 1, wherein the verification engine is further configured to provide a second user interface configured to enable a user to define at least a portion of the annotation event.

17. The source verification system of claim 16, wherein the second user interface allows a user to identify a boundary within the first source document.
